(19) United States
(12) Patent Application Publication
(10) Pub. No.: US 2026/0274456 A1
(43) Pub. Date: Sep. 17, 2026

(54) System And Method For Transporting A Package

(71) Applicant: Variable UAV, Inc., Dover, DE (US)

(72) Inventor: Christopher Bennett, Middletown, OH (US)

(21) Appl. No.: 19/469,040

(22) PCT Filed: Mar. 28, 2024
(86) PCT No.: PCT/US2024/021936

§ 371 Date: Sep. 25, 2025

Related U.S. Application Data
(60) Provisional application No. 63/455,389, filed on Mar. 29, 2023.

(51) Int. Cl. B64U 10/14; B64D 1/12; B64D 1/22; B64U 101/66

(52) U.S. Cl. CPC B64U 10/14; B64D 1/12; B64D 1/22; B64U 2101/66

(57) ABSTRACT

A package transport system includes an unmanned aerial vehicle (UAV) including a body having a front portion. The body has a slot with an opening disposed proximate the front portion The slot terminates with a receiving socket disposed opposite the opening. The UAV further includes at least one propulsion unit operatively coupled to the body and configured to generate a first propulsive force. The package transport system also includes a package securing arrangement configured to secure a package for transport. The package securing arrangement has a mast and a top element atop the mast The top element is configured to nest within the receiving socket when the package is being transported. Methods for transporting a package are also disclosed.

### CROSS REFERENCE TO RELATED APPLICATION

This application claims the benefit of U.S. Provisional Patent Application Ser. No. 63/455,389, filed Mar. 29, 2023, the disclosure of which is incorporated by reference herein in its entirety.

### TECHNICAL FIELD

The invention relates generally to a system and method for transporting a package and, more particularly, delivering a package from a residential or business customer or retrieving the package from a residential or business customer, for example.

### BACKGROUND

Package delivery and retrieval at private residences and businesses has become an every-day occurrence. The ubiquity of package delivery and retrieval has led to a drastic need for delivery and retrieval technology and personnel. The primary means for package delivery and retrieval is commercial carriers such as United Parcel Service and Federal Express, with other largescale operations such as Amazon quickly becoming equally predominant sources for package delivery and retrieval.

Not unique amongst delivery curriers—and others, e.g., the United States Postal Service—is the need for human participation in the delivery and retrieval process. Humans serve as drivers and physical couriers and often must travel great distances to meet their daily delivery and retrieval quotas. Consequently, human drivers must stop at private residences, businesses, restaurants, and other locations, some of which are not easily accessible by ground-based vehicles such as delivery vans and trucks. For example, a delivery currier may need to deliver packages at a private residence located on a busy thoroughfare, requiring the courier to abruptly stop his/her vehicle amidst traffic, obtain the package(s) to be delivered or retrieved, approach the residence, and then return to his/her vehicle and reenter traffic from a stationary perspective. In addition, latent dangers may be present at or around the private residence such as pets, landscape, and fences that the courier may encounter. The dangers associated with being a human courier are significant and have led delivery curriers, and others, to explore package delivery and retrieval systems that require little to no human intervention.

One approach to reducing human intervention in package delivery uses an unmanned aerial vehicle (UAV). In that regard, systems, apparatuses, and methods for package delivery using UAVs are becoming more prevalent. However, there are deficiencies in those current UAV-based package delivery systems which have inhibited them from becoming an every-day norm.

For example, nearly all UAV-based package delivery systems are limited to just that: package delivery. Package retrieval from a home or business is practically impossible. Mass-produced drones that lack highly sophisticated robotic appendages, cannot manipulate a package in order to permit package retrieval. Additionally, it can be dangerous and unnerving for homeowners to assist and/or engage an active retrieval drone. Thus, current UAV-based package delivery systems are not efficient because they are limited to only one capability: package delivery.

Another deficiency associated with UAV-based package delivery is the conventional means by which packages are secured to the UAV. Many UAV-based package delivery systems employ a retractable wire or cable which fastens to the package via claw or clasp. These cables are not rigid and do not prevent the package from pitching or yawing during flight. In addition, a cable-based delivery system cannot be deployed during adverse weather such as rain or high wind due to the effect a pitching or yawing package would have on flight stability of the UAV. Other UAV-based package delivery techniques simply cause the package to be dropped from a cargo bay within the UAV without any means for securing the package or ensuring safe deposit. These UAV-based package delivery systems also cannot be deployed during adverse weather conditions as the package drop must be calculated to land within a specified target zone, and factors such as wind, humidity, true airspeed, groundspeed, payload, and others must be correctly calculated to permit a safe drop. Furthermore, a free-falling package delivery method suffers from other deficiencies such as an inability for package retrieval (as previously mentioned) and limitations of use based on the content of the package. Easily destructible content may not be contained in a package that is delivered via free-fall.

There are many other examples of deficiencies in UAV-based delivery systems which are too numerous to fully detail. Flight stability based on payload and adaptability based on package attachment devices are just a few more examples.

### SUMMARY OF THE INVENTION

In one aspect of the disclosure, a package transport system is disclosed. The package transport system includes an unmanned aerial vehicle (UAV) including a body having a front portion. The body has a slot with an opening disposed proximate the front portion. The slot terminates with a receiving socket disposed opposite the opening. The UAV also includes at least one propulsion unit operatively coupled to the body and configured to generate a first propulsive force. The package transport system also includes a package securing arrangement configured to secure a package for transport. The package securing arrangement has a mast and a top element atop the mast. The top element is configured to nest within the receiving socket when the package is being transported.

The UAV may include a scanner configured to read a two-dimensional barcode affixed to the package. The UAV may include an optical camera. The UAV may include an infrared camera.

In an embodiment, the package securing arrangement may further include at least one strap and a strap guide member coupled to the mast. The strap guide member is configured to receive the at least one strap.

In an embodiment, the top element may include an engagement member and the receiving socket may include a complimentary engagement member. The engagement member of the top element may be configured to engage the complimentary engagement member of the receiving socket such that the package securing arrangement does not rotate relative to the UAV when the UAV is transporting the package.

In an embodiment, the UAV further includes a pair of stabilizing members coupled to an underside of the body of the UAV. Each of the stabilizing members is arcuate and flexible and configured to contact an upward surface of the package while the UAV is transporting the package.

In an embodiment, the UAV may further include an auxiliary propulsion unit operatively coupled to the body. The auxiliary propulsion unit configured to generate a second propulsive force that is generally perpendicular to the first propulsive force of the at least one propulsion unit.

In another aspect of the disclosure an unmanned aerial vehicle (UAV) is disclosed. The UAV includes a body having a front portion. The body has a slot with an opening disposed proximate the front portion. The slot terminates with a receiving socket disposed opposite the opening. The at least one propulsion unit is operatively coupled to the body and configured to generate a first propulsive force. The receiving socket configured to receive a top element of a package securing arrangement.

In one embodiment, the UAV may include a pair of stabilizing members coupled to an underside of the body of the UAV. Each of the stabilizing members may be arcuate and flexible.

In one embodiment, the UAV may further include an auxiliary propulsion unit operatively coupled to the body, the auxiliary propulsion unit configured to generate a second propulsive force that is generally perpendicular to the first propulsive force.

In another aspect of the disclosure, a method for transporting a package is disclosed. The method includes providing an unmanned aerial vehicle (UAV) at a launch area. The UAV includes a body having a front portion. The body has a slot with an opening disposed proximate the front portion. The slot terminates with a receiving socket disposed opposite the opening. The UAV further includes at least one propulsion unit operatively coupled to the body and configured to generate a first propulsive force. The method includes securing a package securing arrangement having a mast and a top element to a package. The method includes operating the UAV so that mast translates along the slot. The method includes operating the UAV so that the package securing arrangement couples to the receiving socket. The method includes operating the UAV along a flight trajectory to a desired location.

In one embodiment, the method further includes operating the UAV to uncouple the package securing arrangement from the receiving socket and operating the UAV back to the launch area.

In one embodiment, coupling of the package securing arrangement to the receiving socket includes nesting the top element with the receiving socket.

In one embodiment, the UAV includes a pair of stabilizing members. The stabilizing members are configured to contact an upper surface of the package as the mast translates along the slot.

In one embodiment, the UAV may include a scanner and the method further includes operating the UAV to scan a two-dimensional barcode affixed to a surface of the package at least prior to coupling the package securing arrangement to the receiving socket.

In one embodiment, the UAV further includes an auxiliary propulsion unit operatively coupled to the body, the auxiliary propulsion unit configured to generate a second propulsive force that is generally perpendicular to the first propulsive force of the at least one propulsion unit.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a delivery system according to an embodiment of the invention with a UAV coupled to a package.

FIG. 2 is a perspective view of the delivery system of FIG. 1 with the UAV uncoupled from the package.

FIG. 3 is a partial cross-sectional view schematically illustrating an engagement member of the mast ready to engage an engagement member on the UAV of FIG. 1.

FIG. 4A is an elevational view of the delivery system of FIG. 1 in a first stage of the process of coupling the UAV to the package.

FIG. 4B is an elevational view of the delivery system of FIG. 1 in a second stage of the process of coupling the UAV to the package.

FIG. 4C is a partial cross-sectional, elevational view of the delivery system illustrating the engagement member of the connection member engaged with the engagement member on the UAV.

FIG. 4D is an elevational view of the delivery system of FIG. 1 with the UAV coupled to the package lifted off the ground.

FIG. 5 is a perspective view of a delivery system according to another embodiment of the invention coupled to the package.

### DETAILED DESCRIPTION OF THE INVENTION

In the following detailed description of the illustrative embodiments, reference is made to the accompanying drawings that form a part hereof, and in which is shown by way of illustration specific preferred embodiment in which the invention may be practiced. These embodiments are described in sufficient detail to enable those skilled in the art to practice the invention, and it is understood that other embodiments may be utilized, and that logical structural, mechanical, electrical, and other changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

As used herein, related terms such as “package,” “cargo,” and “payload,” may be used interchangeably. As used herein, related terms such as “UAV” and “drone” may be used interchangeably.

As used herein, “lateral” or “transverse” indicates a side-to-side direction. “Top” refers to a generally upwardly-facing area of the UAV during normal takeoff, flight, and descent. “Bottom” refers to a generally downwardly-facing area of the UAV during normal takeoff, flight, and descent. “Up” refers to generally vertically-ascending movement of an object relative to the ground or a grounded surface. “Down” refers to generally vertically-descending movement of an object relative to the ground or a grounded surface. “Front” refers to a generally forward-facing area or portion of the UAV which features an opening of a slot as described below. “Forward” refers to movement where the front of the UAV leads the movement. “Rear” refers to a generally rear-facing area or portion of the UAV opposite of the front having the opening of the slot as described below. “Rearward” refers to movement where the rear of the UAV leads the movement.

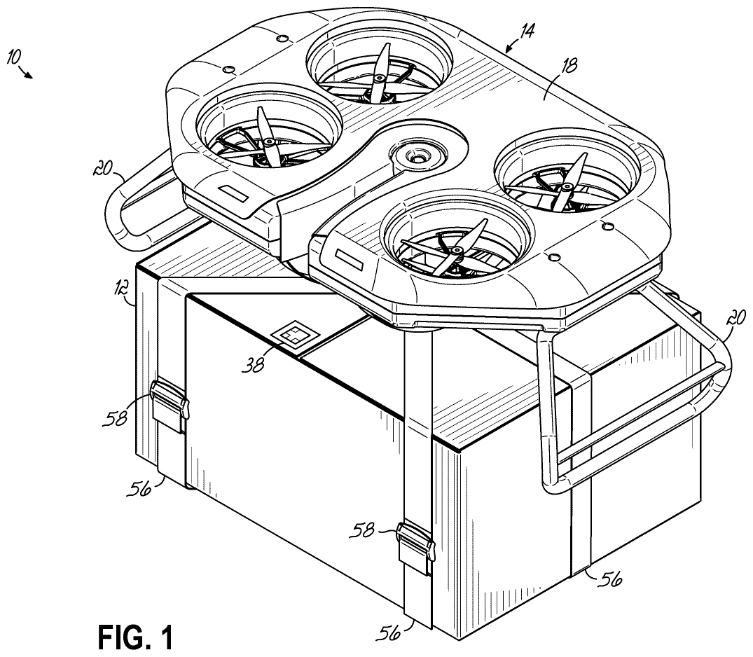

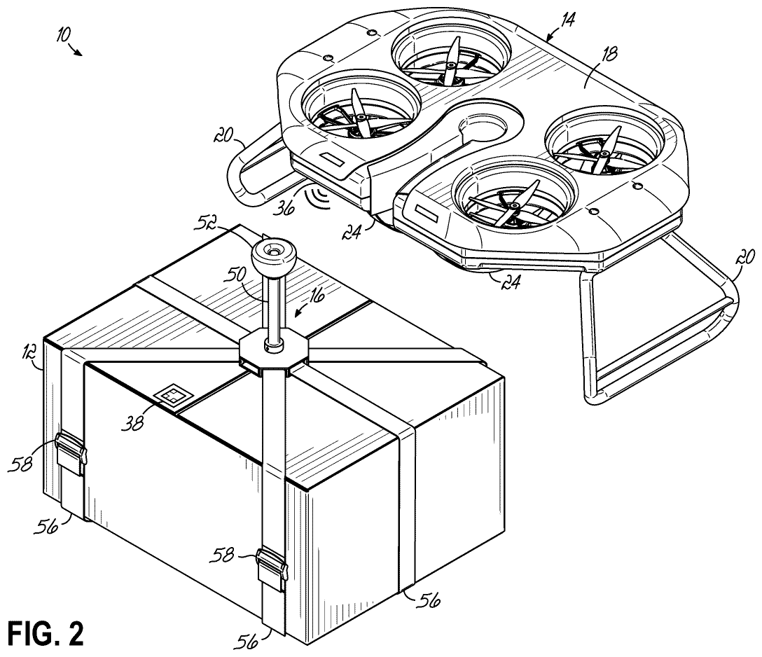

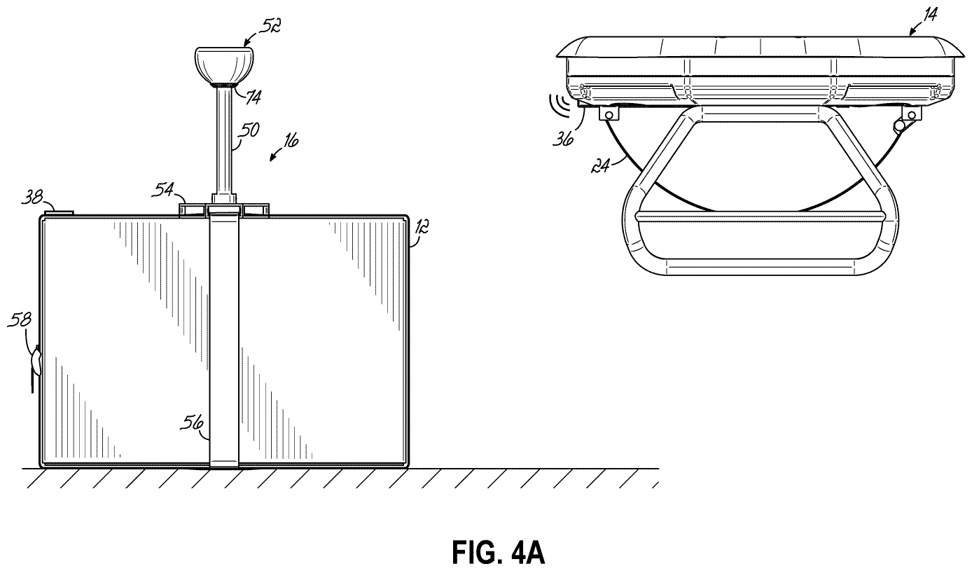

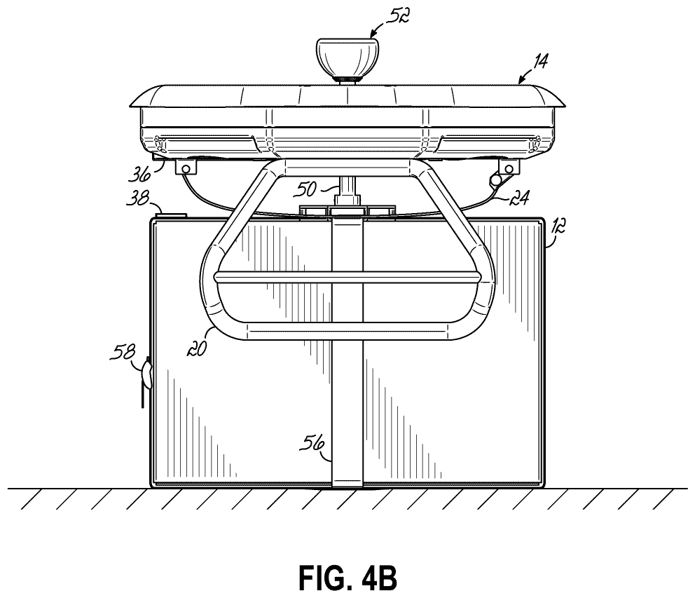

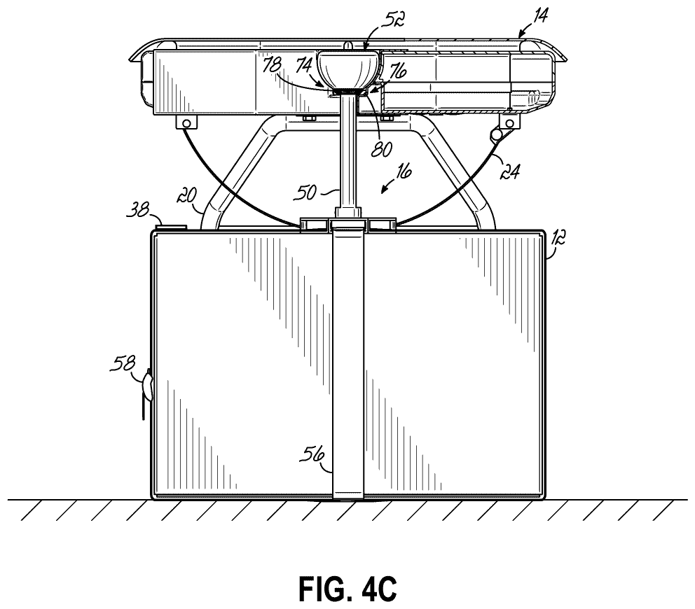

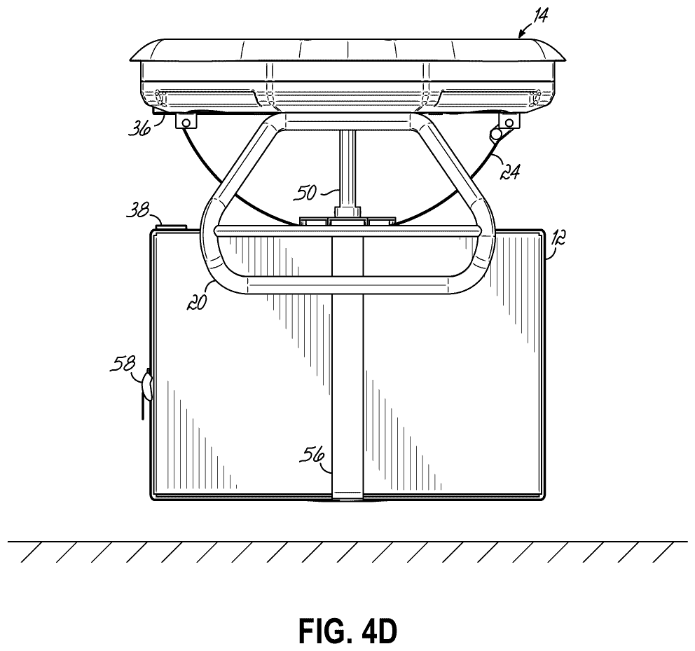

With reference to FIGS. 1 and 2, a package transport system 10 for delivering or retrieving a package 12 is shown according to an embodiment of the invention. The package transport system 10 includes a UAV 14 and a package securing arrangement 16, which selectively, removably couples to the package 12. The UAV 14 includes a body 18 and a pair of spaced-apart legs 20 to support the UAV 14 when the UAV 14 is positioned on a support surface. The body 18 may include four propulsion units 22 configured to operate in a coordinated manner to move the UAV 14 forward, rearward, laterally, up, and down. Each propulsion unit 22 is configured to generate a propulsive force in a substantially vertical orientation. To that end, the propulsion units 22 may be controlled through a remote control unit manipulated by a user. Alternatively, the UAV 14 may have an onboard controller that autonomously controls the propulsion units 22. The body 18 may also include a pair of spaced-apart stabilizing members 24, which extend generally parallel to the legs 20. See also FIG. 4A. The body may also include a slot 26 with an opening 28 proximate front portion 34 of the UAV 14. The UAV 14 may also include an optical camera 30 and/or an infrared camera 32 positioned in the front portion 34 of the body 18. The optical camera 30 and the infrared camera 32 may assist the UAV 14 navigate to a desired location and avoid hitting obstacles during the trip. The UAV 14 may also include a scanner 36 (FIG. 4A) that is configured to read a two-dimensional barcode 38, such as a Quick Response code (QR code), that is located on the package 12, preferably located on the top of the package 12. The barcode 38 on the package 12 may contain various information, including the contents of the package 12, the weight of the package, the name and address of the sender of the package 12, and the name and address of the receiver of the package 12, for example.

The package securing arrangement 16 may include an elongated mast 50 with a top element 52 secured to the top of the elongated mast 50 and a strap guide member 54 at the bottom of the elongated mast 50. The package securing arrangement 16 may also include one or more straps 56 that pass through the strap guide member 54 and wrap around the sides of the package 12. The straps 56 may include one or more strap retaining members 58, suck as buckles, to keep the straps 56 in a tightened condition around the package 12. The strap retaining members 58 may be released to provide slack in the straps 56 so that the package 12 may be removed/released from the package securing arrangement 16. The mast 50, the top element 52, and the strap guide member 54 may be constructed as a single unitary unit, such as by additive manufacturing, i.e., 3-D printing. The slot 26 is sized to allow the mast 50 to transverse the length of the slot 26 from the opening 28 to the receiving socket 64.

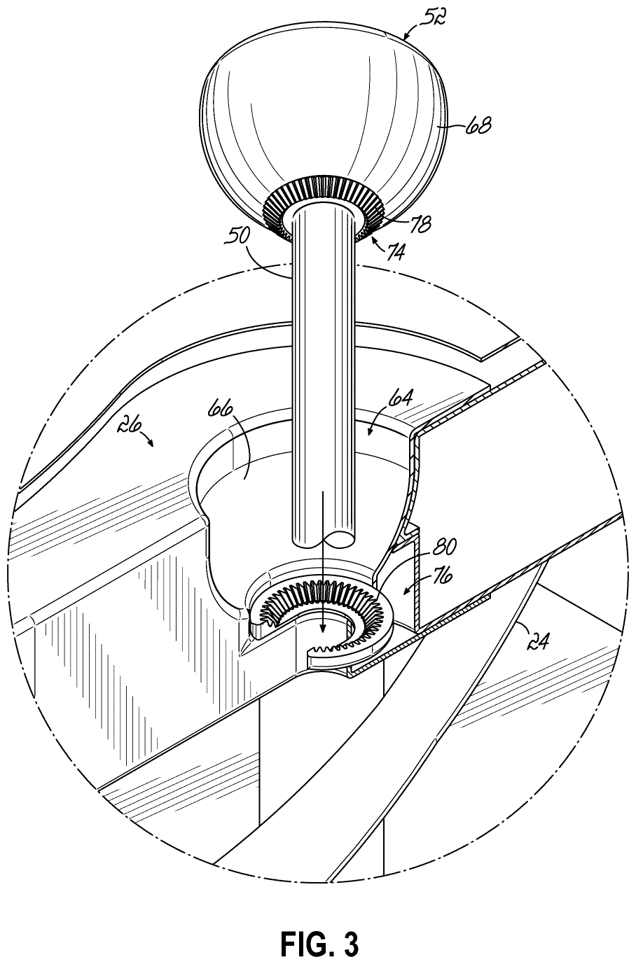

With reference to FIG. 3, the slot 26 includes a receiving socket 64 at the end of the slot 26 opposite the opening 28. The receiving socket 64 is configured to receive the top element 52. In one aspect, the receiving socket 64 may have surface 66 that is shaped to generally match the shape of an outside surface 68 of the top element 52. As such, the outside surface 68 of the top element 52 may nest within the surface 66 of the receiving socket 64. While the outside surface 68 of the top element 52 and the surface 66 of the receiving socket 64 each have a generally spherical shape as shown in FIG. 3, the outside surface 68 and the surface 66 may have other complimentary shapes to allow the top element 52 to nest inside the receiving socket 64. In another aspect, the top element 52 may include an engagement member 74 and the receiving socket 64 may include a complimentary engagement member 76. The engagement member 74 may have a topographic surface 78 that interlocks with a complimentary topographic surface 80 on the complimentary engagement member 76. In one aspect and as shown in exemplary fashion in FIG. 3, the topographic surface 78 may include a plurality of circumferentially arranged teeth and the complimentary topographic surface 80 has corresponding grooves to receive the teeth. In use, the topographic surface 78 (e.g., teeth) mates or engages with the complimentary topographic surface 80 (e.g., grooves) such that the mast 50 and the top element 52 will not rotate relative to the UAV 14 under normal operating conditions. The flight trajectory and/or the stability of the UAV 14 may be disrupted or impeded if the package 12 and package securing arrangement 16 are allowed to spin relative to the UAV 14 while the UAV 14 is carrying the package 12 to the desired location.

The process of coupling the UAV 14 to the package 12 will be explained with reference to FIGS. 4A-4D. When the package 12 is to be delivered to a customer or returned to the shipper by the customer, the package securing arrangement 16 is coupled to the package 12 with the straps tightened around the package 12. In the situation where the package 12 is being delivered to a customer, a delivery person for a commercial carrier (e.g., FedEx, UPS, etc.) places the package outside of a delivery vehicle, such as on the ground or a launch pad. The delivery person activates the UAV 14, which is either inside the delivery vehicle or outside the delivery vehicle, such as by an application on a hand-held device or other communication device, such as a phone, tablet, or laptop computer. The application on the hand-held device may transmit the delivery information about the package 12 and where the package 12 is currently located so the UAV 14 may locate the package 12 once the UAV 14 becomes airborne. With this information now onboard, the UAV 14 may autonomously fly to the package 12, which has the two-dimensional barcode 38 placed thereon, such as on the top panel of the package 12. The optical camera 30 may be used to locate the package 12 when the UAV 14 is airborne and assist the UAV 14 to couple itself to the package 12. Alternatively, the delivery person may choose to fly the UAV 14 to the package 12 using the hand-held device which may receive a real-time picture of the UAV's 14 position from the optical camera 30.

Upon liftoff, the UAV 14 moves forward approaching the package 12 so the opening 28 of the slot 26 is facing the mast 50. As the UAV 14 approaches the package 12, the UAV 14 will need to be at an elevation to allow the mast 50 to travel through the slot 26 while the top element 52 is above the UAV 14. See FIG. 4B. As the UAV 14 is flown at this elevation, the stabilizing members 24 contact the top of the package 12 and deflect as shown in FIG. 4B. When the mast 50 is located at the back of the slot 26, i.e., at the end of the slot 26 opposite from the opening 28, the UAV 14 flies upwardly so that the top element 52 nests within the receiving socket 64 and, more particularly, the engagement member 74 on the top element 52 is engaged with engagement member 76 of the receiving socket 64 as shown in FIG. 4C. When the UAV 14 lifts the package 12 off the ground (FIG. 4D), the stabilizing members 24 are configured to just barely contact or reside just above the top surface of the package 12 so as to stabilize the package 12 as it is being transported to the desired location. The stabilizing members 24 may be arcuate in shape and flexible such that if the package 12 moves relative to the UAV 14 during flight, the stabilizing members 24 may deflect and then push the package 12 back to its undisturbed position relative to the UAV 14. The UAV 14 may fly autonomously to the desired location using the position information, i.e., the customer's address, obtained from the two-dimensional barcode 38 on the package 12. Alternatively, the delivery person may fly the UAV 14 and the attached package 12 the customer's location using the hand-held device and the optical camera 30 on the UAV 14.

When the package 12 arrives at the desired location, the UAV 14 moves downward until the bottom of the package 12 rests upon a supporting surface, such as the ground or a designated landing area. The UAV 14 then drops down so that the top element 52 is above the UAV 14 and the UAV 14 moves rearward until the mast 50 is clear from the slot 26. With the UAV 14 uncoupled from the package 12, the UAV 14 returns to the starting point where the delivery person will collect the UAV 14 and use it again, if needed, to deliver another package 12. The customer may then remove the package securing arrangement 16 from the package 12 and open the package 12. If the product(s) inside the package 12 is acceptable to the customer, the customer may dispose of the package securing arrangement 16 or return it to the commercial carrier where the commercial carrier may reuse it again.

If the customer wishes to return the product(s), the customer may arrange for the commercial carrier to retrieve the product(s) in a manner similar to how the product(s) was initially delivered. To that end, the customer would place the package securing arrangement 16 around the package 12 containing the product(s) and place the package 12 in a location that is accessible by the UAV 14. The customer would then contact the commercial carrier to inform them that the package 12 is ready to be picked up. The delivery driver would position the delivery vehicle within a reasonable range of the customer's location, e.g., more than 1 mile, more than 2 miles, more than 3 miles, more than 4 miles, or more than 5 miles, such that the UAV 14 may fly to and from the customer's location on a single charge of its onboard batteries. The delivery person may activate the UAV 14 via the hand-held device and upload the customer's location into the UAV 14. The UAV 14 may then fly autonomously to the customer's location and then locate the package 12 via a GPS tracking device, for example. Once on site, the UAV 14 may locate the exact location of the package 12 via the optical camera 30. The UAV 14 may then connect to the package 12 as described above. When the UAV 14 is connected to the package 12, the UAV 14 may lift off and autonomously carry the package 12 to the delivery person waiting at the delivery vehicle. Alternatively, the delivery person may fly the UAV 14 to the package 12 using the hand-held device. The delivery person may then maneuver the UAV 14 so as to connect to the mast 50. Once connected the delivery person may fly the UAV 14 back to the delivery vehicle.

To maneuver the UAV 14 in a desired direction, i.e., up, down, front, back, and laterally left or right, the thrust delivered by each propulsion unit 22 may be varied individually to cause motion in the desired direction. For example, to move forward, the two rear propulsion units 22 generate slightly more propulsive force than the two front propulsion units 22. This imbalance in propulsive force causes the body 18 of the UAV 14 to tilt forward to some degree such that some component of the propulsive force is oriented forwardly, thereby causing the UAV 14 to move forward. The titled body 18 may make it more challenging for the UAV 14 to move from the position depicted in FIG. 4A to the position depicted in FIG. 4B, i.e., the connection process, (and vice versa, the disconnection process) as the slot 26 may not be fully below the top element 52 such that the top element 52 impedes the forward movement of the UAV 14.

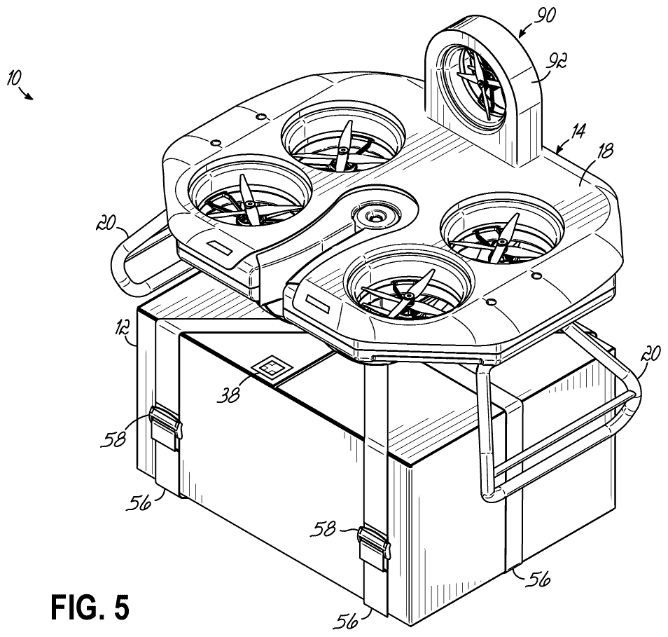

To alleviate or minimize the tilting of the UAV 14 during the connection/disconnection process, an embodiment of the UAV 14 may include an auxiliary propulsion unit 90 enclosed in a housing 92 extending vertically from the body 18 as shown in FIG. 5. The auxiliary propulsion unit 90 is configured to generate a propulsive force in a substantially horizontal orientation essentially perpendicular to the propulsive force generated by the propulsion units 22. During the connection or disconnection process, each of the propulsion units 22 generates essentially the same propulsive force so that the body 18 of the UAV remains relatively level while the auxiliary propulsion unit 90 generates either a forward or rearward propulsive force to move the UAV 14 either forward or rearward.

Embodiments of the UAV 14 may feature internal programming, software, or operating systems configured to provide autonomous operation of the UAV 14. For example, a user or delivery person may be able to use the hand-held device to manually enter data such as mapping coordinates, meteorological conditions, package weight, remaining UAV power/fuel parameters, and/or other information into operating systems or software within the UAV 14 so as to permit autonomous delivery with little to no human control. Enty of that data from externally quantifiable factors—such as those previously mentioned—should enable the UAV 14 to safely and autonomously deliver or retrieve the package 12 by preparing an autonomous flight plan tailored to account for variable entries. Embodiments of the UAV 14 may also feature internal programming, software, or operating systems configured to provide autonomous operation that do not require any human data entry. For example, the UAV 14 may be outfitted with software and/or physical features like scales, wind speed gauges, optical sensors, cameras 30, or precipitation meters that automatically identify critical values that, in turn, may be automatically entered into operating systems, software, or latent data fields within the UAV 14. This date should enable the UAV 14 to safely and autonomously deliver or retrieve the package 12 by preparing an autonomous flight plan tailored to account for variable entries without human data entry and/or subsequent control. As discussed above, the package 12 may have a two-dimensional barcode 38 affixed to an outer surface of the package 12. That two-dimensional barcode 38 may be read by the optical camera 30. Alternatively, the package securing arrangement 16 may be embedded with a radio-frequency identification (RFID) chip that hones the UAV 14 based on recognition of the appropriate radio-frequency by the UAV 14, which may include an RFID receiver. The two-dimensional barcode 38 and the RFID chip permit the UAV 14 to recognize the package 12 and hone in on the package 12 autonomously. Even when numerous packages are also present at a retrieval location such as an apartment complex, commercial office building, or the like. In autonomous embodiments such as those described herein, users may be able to retain emergency manual control in the event of mechanical or computer malfunctions.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

I claim:

1. A package transport system, comprising:
an unmanned aerial vehicle (UAV) including:
a body having a front portion, the body having a slot with an opening disposed proximate the front portion, the slot terminating with a receiving socket disposed opposite the opening;
at least one propulsion unit operatively coupled to the body and configured to generate a first propulsive force;
a package securing arrangement configured to secure a package for transport, the package securing arrangement having a mast and a top element atop the mast, the top element configured to nest within the receiving socket when the package is being transported.

2. The package transport system of claim 1, wherein the UAV includes a scanner configured to read a two-dimensional barcode affixed to the package.

3. The package transport system of claim 1, wherein the UAV includes an optical camera.

4. The package transport system of claim 1, wherein the UAV includes an infrared camera.

5. The package transport system of claim 1, wherein the package securing arrangement further includes at least one strap and a strap guide member coupled to the mast, the strap guide member configured to receive the at least one strap.

6. The package transport system of claim 1, wherein the top element includes an engagement member and the receiving socket includes a complimentary engagement member, the engagement member of the top element is configured to engage the complimentary engagement member of the receiving socket such that the package securing arrangement does not rotate relative to the UAV when the UAV is transporting the package.

7. The package transport system of claim 1, wherein the UAV further includes a pair of stabilizing members coupled to an underside of the body of the UAV.

8. The package transport system of claim 7, wherein each of the stabilizing members is arcuate and flexible and configured to contact an upward surface of the package while the UAV is transporting the package.

9. The package transport system of claim 1, wherein the UAV further includes an auxiliary propulsion unit operatively coupled to the body, the auxiliary propulsion unit configured to generate a second propulsive force that is generally perpendicular to the first propulsive force.

10. An unmanned aerial vehicle (UAV) comprising:
a body having a front portion, the body having a slot with an opening disposed proximate the front portion, the slot terminating with a receiving socket disposed opposite the opening; and
at least one propulsion unit operatively coupled to the body and configured to generate a first propulsive force,
wherein the receiving socket configured to receive a top element of a package securing arrangement.

11. The unmanned aerial vehicle of claim 10, further comprising:
a pair of stabilizing members coupled to an underside of the body of the UAV, each of the stabilizing members being arcuate and flexible.

12. The unmanned aerial vehicle of claim 10, wherein the UAV further includes an auxiliary propulsion unit operatively coupled to the body, the auxiliary propulsion unit configured to generate a second propulsive force that is generally perpendicular to the first propulsive force.

13. A method for transporting a package comprising:
providing an unmanned aerial vehicle (UAV) at a launch area, the UAV including:
a body having a front portion, the body having a slot with an opening disposed proximate the front portion, the slot terminating with a receiving socket disposed opposite the opening;
at least one propulsion unit operatively coupled to the body and configured to generate a first propulsive force;
securing a package securing arrangement having a mast and a top element to a package;
operating the UAV so that mast translates along the slot;
operating the UAV so that the package securing arrangement couples to the receiving socket; and
operating the UAV along a flight trajectory to a desired location.

14. The method of claim 13, further comprising:
operating the UAV to uncouple the package securing arrangement from the receiving socket; and
operating the UAV back to the launch area.

15. The method of claim 13, wherein the coupling of the package securing arrangement to the receiving socket includes nesting the top element with the receiving socket.

16. The method of claim 13, wherein the UAV includes a pair of stabilizing members, the stabilizing members configured to contact an upper surface of the package as the mast translates along the slot.

17. The method of claim 13, wherein the UAV includes a scanner, the method further comprising:
operating the UAV to scan a two-dimensional barcode affixed to a surface of the package at least prior to coupling the package securing arrangement to the receiving socket.

18. The method of claim 13, wherein the UAV further includes an auxiliary propulsion unit operatively coupled to the body, the auxiliary propulsion unit configured to generate a second propulsive force that is generally perpendicular to the first propulsive force.
